(19) United States
(12) Patent Application Publication
(10) Pub. No.: US 2009/0191068 A1
(43) Pub. Date: Jul. 30, 2009

(54) VARIABLE VOLUME RESERVOIR

(75) Inventors: Joseph A. St. Aubin, Wahpeton, ND (US); Knute K. Brock, Bismarck, ND (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: CLARK EQUIPMENT COMPANY, West Fargo, ND (US)

(21) Appl. No.: 12/021,751

(22) Filed: Jan. 29, 2008

(51) Int. Cl. F04B 7/04; F15B 1/04; F04B 1/00

(52) U.S. Cl. 417/231; 138/30; 417/499

(57) ABSTRACT

A reservoir for a hydraulic pump system includes a reservoir body, an inner wall dividing an interior of the reservoir body into a first pressure chamber and a second pressure chamber, and a one-way valve connecting the first pressure chamber and the second pressure chamber. A piston assembly forms a first cylinder portion connected to the first pressure chamber and a second cylinder portion that is vented. The piston is movable within the cylinder under the influence of a biasing member to increase and decrease the overall volume of the first pressure chamber. The piston pressures a piston pump inlet connected to the first pressure chamber and maintains a constant pressure within the first pressure chamber under a variety of piston pump operating conditions.

### FIELD OF THE INVENTION

The present invention relates to a reservoir for a hydraulic pump system.

### SUMMARY

In one embodiment, the invention provides a reservoir for a hydraulic pump system. The reservoir includes a reservoir body, an inner wall dividing an interior of the reservoir body into a first pressure chamber and a second pressure chamber, and a one-way valve connecting the first pressure chamber and the second pressure chamber for selectively permitting fluid to flow from the first pressure chamber into the second pressure chamber. The reservoir also includes a piston assembly having a cylinder and a movable piston A first side of the piston and the cylinder form a first cylinder portion and a second side of the piston and the cylinder form a second cylinder portion. The first pressure chamber is in fluid communication with the first cylinder chamber. A biasing member biases the piston towards the first cylinder portion.

In another embodiment the invention provides a hydraulic pump system for a work machine. The hydraulic pump system includes a reservoir having a first pressure chamber and a second pressure chamber, and a one-way valve connecting the first pressure chamber and the second pressure chamber for selectively permitting fluid to flow from the first pressure chamber into the second pressure chamber. The reservoir also includes a piston assembly having a cylinder and a piston A first side of the piston and the cylinder form a first cylinder portion and a second side of the piston and the cylinder form a second cylinder portion. The first pressure chamber is in fluid communication with the first cylinder portion. A biasing member biases the piston towards the first cylinder portion. The hydraulic pump system also includes a primary pump loop connecting to the reservoir, wherein fluid in the primary pump loop flows from the first pressure chamber, through the primary pump loop and into the first pressure chamber and, and a secondary pump loop connecting to the reservoir, wherein fluid in the secondary pump loop flows from the second pressure chamber, through the secondary pump loop and into the first pressure chamber.

In another embodiment, the invention provides a reservoir for a hydraulic pump system. The reservoir includes a first pressure chamber, a second pressure chamber and a passageway connecting the second pressure chamber to the first pressure chamber. A movable body is positioned in the passageway and seals the first pressure chamber from the second pressure chamber. The body is movable between a first position in which the first pressure chamber has a first volume and a second position in which the first pressure chamber has a second volume. The reservoir also includes a one-way valve between the first pressure chamber and the second pressure chamber.

Other aspects of the invention will become apparent by consideration of the detailed description and accompanying drawings.

### BRIEF DESCRIPTION OF THE DRAWINGS

FIG. 1 is a perspective view of a work machine according to an embodiment of this invention.

FIG. 2 schematically illustrates a hydraulic pump system according to an embodiment of the invention.

FIG. 3 schematically illustrates a reservoir according to another embodiment of the invention.

FIG. 4 schematically illustrates the cylinder of FIG. 2 without a seal according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

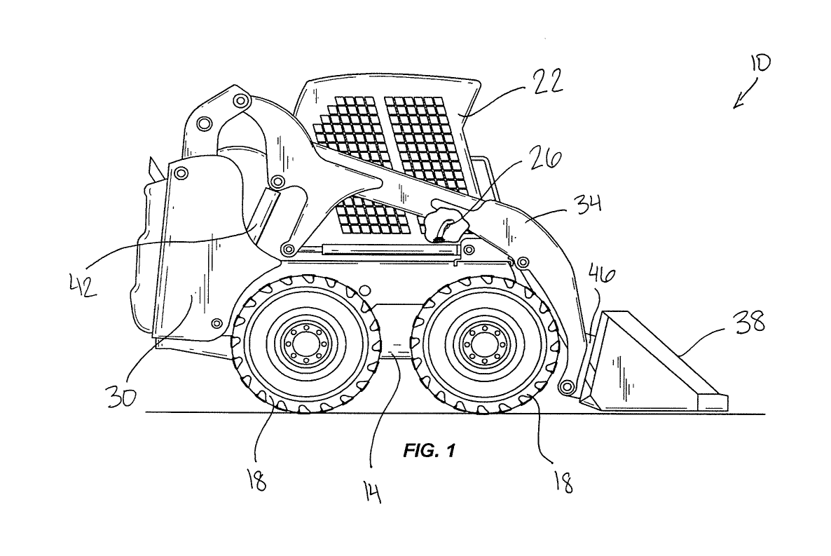

FIG. 1 illustrates a work machine 10 that includes a frame 14 supported for movement over the ground by front and rear pairs of wheels 18. An operator cab 22 is mounted to the frame 14 and includes an operator control 26 for controlling operation of the work machine 10. An engine 30 is mounted to the frame 14 and provides a power source for moving the wheels 18 and also for other systems. The engine 30 can be an internal combustion engine, a hydraulic engine, etc. A pair of work arms 34 are pivotally mounted to a rear of the frame 14 and include a bucket 38 at a distal end thereof. One or more hydraulic lift cylinders 42 are coupled between the frame 14 and the work arms 34 for raising and lowering the work arms 34. One or more hydraulic tilt cylinders 46 are coupled between the work arms 34 and the bucket 38 for tilting the bucket 38.

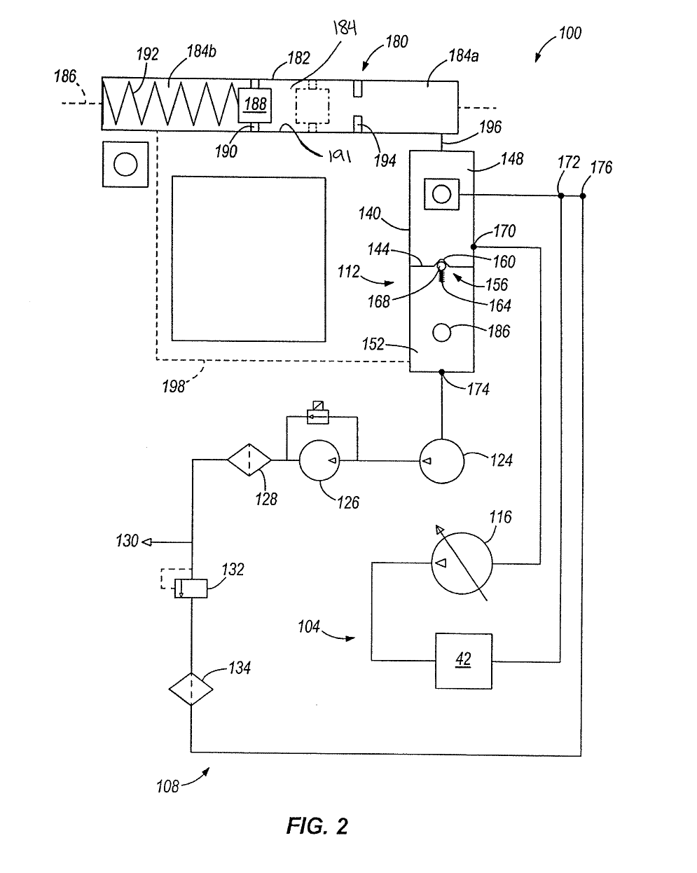

FIG. 2 illustrates a hydraulic pump system 100 according to an embodiment of the invention. The hydraulic pump system 100 can be used to provide fluid pressure for operating or powering a primary hydraulic system of the work machine 10 such as the lift cylinder 42 and/or the tilt cylinder 46 and other auxiliary or secondary hydraulic systems. The hydraulic pump system 100 can be incorporated into a variety of work machines. The work machine 10 is merely exemplary of such a work machine.

The hydraulic pump system 100 includes a primary pump loop 104, a secondary pump loop 108 and a reservoir 112 for supplying fluid to the primary pump loop 104 and the secondary pump loop 108. The primary pump loop 104 includes a piston pump 116 that is powered by the engine 30. The piston pump 116 draws pressurized fluid from the reservoir 112 and pumps it to a primary system such as the lift cylinder 42. The primary pump loop 104 returns fluid from the lift cylinder 42 to the reservoir 112.

The secondary pump loop 108 includes a charge pump 124 that draws fluid from the reservoir 112 and pumps it to secondary systems, including, for example, a fan 126, a fan filter 128, auxiliary hydraulics 130, a charge relief 132, and an oil cooler 134. The secondary pump loop 108 also returns fluid to the reservoir 112.

The reservoir 112 includes a reservoir body 140 having an inner wall 144. The inner wall 144 partitions the interior of the reservoir body 140 into a first or pressurized chamber 148 and a second or vented chamber 152. A valve 156 permits fluid to flow one way only through an opening 160 in the inner wall 144 from the pressurized chamber 148 to the vented chamber 152. In other embodiments, the valve 156 can be exterior to the reservoir 112. In the illustrated embodiment., the valve 156 includes a biasing member 164 that biases a check ball 168 into a closed, sealing engagement with the inner wall 144 at the opening 160. The valve 156 has a valve closing force that is a function of the biasing force of the valve biasing member 164. The valve closing force sets a maximum pressure within the pressurized chamber 148.

The reservoir 112 includes a primary pump loop outlet 170 at the pressurized chamber 148, a primary pump loop inlet 172 at the pressurized chamber 148, a secondary pump loop outlet 174 at the vented chamber 152 and a secondary pump loop inlet 176 at the pressurized chamber 148. In some embodiments, the primary pump inlet 172 and the secondary pump inlet 176 are connected. The reservoir 112 also includes an opening 186 in the vented chamber 152 to the ambient pressure.

The piston pump 116 draws pressurized fluid from the pressurized chamber 148 at the primary pump loop outlet 170 and returns fluid to the pressurized chamber 148 at the primary pump loop inlet 172. In contrast, the charge pump 124 draws fluid from the vented chamber 152 at the secondary pump loop outlet 174 and returns fluid to the pressurized chamber 148 at the secondary pump loop inlet 176. In general, the combined return to the pressurized chamber 148 causes the pressure within the pressurized chamber 148 to be greater than that of the vented chamber 152.

In normal operation, the pressure within the pressurized chamber 148 can sometimes exceed the valve closing force, opening the valve 156. When the valve 156 opens, fluid flows from the pressurized chamber 148 to the vented chamber 152, reducing the fluid pressure within the pressurized chamber 148 until the valve 156 recloses. Therefore, pressure within the pressurized chamber 148 is generally less than or equal to the valve closing force.

A piston assembly 180 cooperates with the reservoir 112 to regulate the pressure within the pressurized chamber 148. The piston assembly 180 includes a cylinder 182 forming a cylinder chamber 184 and defining a longitudinal cylinder axis 186. A piston 188 is movable along the axis 186 within the cylinder chamber 184. A seal 190 is positioned between the piston 188 and an inner surface 191 of the cylinder 182. One side of the piston 188 and the cylinder chamber 184 define a first cylinder portion 184a and an opposite side of the piston 188 and the cylinder chamber 184 define a second cylinder portion 184b. The first and second cylinder portions 184a, 184b are sealed from one another so that fluid cannot flow from one to the other. In other embodiments, as shown in FIG. 4, the seal 190 is removed so that there can be some fluid flow around the piston 188 from the first cylinder portion 184a to the second cylinder portion 184b. As illustrated in FIG. 4, fluid can flow through a circumferential gap 193 between the piston 188 and the inner surface 191 of the cylinder 184. This can help to remove air within the cylinder 184 and can reduce drag on the piston 188 for quicker cylinder response times.

The piston assembly 180 includes a biasing member 192 that biases the piston 188 towards the first cylinder portion 184a. In the illustrated embodiment, the biasing member 192 is within the second cylinder portion 184b. Thus, the piston 188 is movable axially between a first position in which the biasing member 192 is more relaxed (shown in dashed lines) and a second position in which the biasing member 192 is more compressed or tensioned (shown in solid lines). The axial position of the piston 188 determines the relative axial length of the first and second cylinder portions 184 a, b and thus the relative volume of the first and second cylinder portions 184a, b.

The piston assembly 180 can include a stop 194 in the cylinder 182 for limiting the movement of the piston 188 axially towards the first cylinder chamber 184a. The stop 194 thus limits the minimum volume (i.e., axial length) of the first cylinder chamber 184a. Movement of the piston 188 is away from the first cylinder portion 184a is limited by full compression of the biasing member 192.

The pressurized chamber 148 of the reservoir body 140 is in fluid communication with the first cylinder portion 184a at 196. The piston 188 exerts a piston or pressurizing force of the fluid within the pressurized chamber under the influence of the biasing member 192. The overall volume of the pressurized chamber 148 includes the volume of the pressurized chamber 148 within the reservoir body 140 plus the volume of the first cylinder portion 184a. When the piston 188 is in the first position, the volume of the first cylinder portion 184a is reduced so that the overall volume of the pressurized chamber 148 is also reduced. Conversely, when the piston 188 is in the second position, the volume of the first cylinder chamber 184a is increased so that the overall volume of the pressurized chamber 148 is also increased.

The vented chamber 152 is connected to the second cylinder portion 184b at 198 and is vented to ambient pressure. In other embodiments, the second cylinder portion 184b lacks fluid and can also be vented to ambient pressure.

Sometimes, the inlet flow to the primary pump loop 104 can be greater than the combined return flow entering the pressurized chamber 148 from the primary pump loop 104 and the secondary pump loop 108. When the aforementioned or another condition occurs which tends to reduce pressure within the pressurized chamber 148, the piston 188 moves towards the first position under the influence of the biasing member 192. This reduces the volume of the first cylinder portion 184a, and therefore reduces the overall volume of the pressurized portion 148. Reducing the overall volume of the pressurized chamber 148 counteracts the reduced pressure within the pressurized chamber 148 so as to maintain an approximately constant pressure within the pressurized chamber 148.

Conversely, when inlet flow to the primary pump loop 104 decreases, the positive flow return to the pressurized chamber 148 can tend to increase the pressure within the pressurized chamber 148. The pressure within the pressurized chamber 148 can overcome the biasing force of the biasing member 192, moving the piston 188 towards the second position. As the piston 188 moves towards the second position, the volume of the first cylinder portion 184a increases, thus increasing the overall volume of the pressurized chamber 148. In this situation, increasing the overall volume of the pressurized chamber 148 counteracts the increased pressure within the pressurized chamber 148 so as to maintain an approximately constant pressure within the pressurized chamber 148.

Axial movement of the piston 188 helps to maintain steady state pressure conditions within the pressurized chamber 148. When the biasing member 192 is fully compressed so that the piston 188 can no longer travel axially away from the first cylinder chamber 184b, pressure within the pressurized chamber 148 can build up. In general, then, the biasing force of the biasing member 192 sets a minimum or steady-state pressure within the pressurized chamber 148 via the piston 188 while the valve closing force sets a maximum pressure within the pressurized chamber 148. In some embodiments, the biasing force is less than the valve closing force. During operation, the pressure within the pressurized chamber 148 can be maintained higher than the valve closing force to hold the valve 156 open unless the reservoir 148 is discharging.

The minimum absolute pressure needed at the primary pump loop outlet 170 to avoid cavitation can change depending upon the speed of the piston pump 116. For example, the minimum absolute pressure required at the primary pump loop outlet 170 in order to avoid cavitation typically increases with rotational speed (i.e., engine RPM) and displacement. Elevation can also increase the minimum gauge pressure (the biasing force of the biasing member 192) required at the primary pump loop outlet 170 to avoid cavitation. The biasing force of the biasing member 192 can be therefore be set to maintain a minimum gauge pressure within the pressurized chamber 148 that is sufficient to avoid cavitation at the primary pump loop outlet 170 at a variety of conditions.

The biasing force exerted on the fluid within the pressurized chamber 148 by the piston 188 is present regardless of the operation of the piston pump 116 and/or the engine 30. Therefore, the primary pump loop outlet 170 is instantly or nearly instantly pressurized or supercharged when the engine 30 is started. There is no need to wait for pressure to build within the pressurized chamber 148 due to thermal expansion of the fluid or other compressed air source.

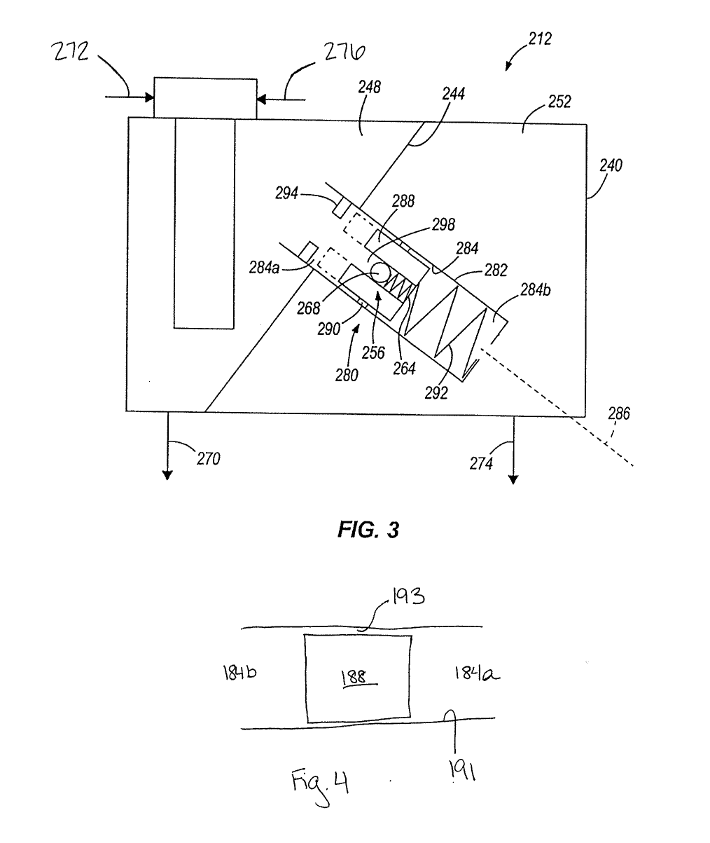

FIG. 3 illustrates a reservoir 212 according to another embodiment of the invention. The reservoir 212 shown in FIG. 3 is similar in many ways to the illustrated embodiment of FIG. 2 described above. Accordingly, with the exception of mutually inconsistent features and elements between the embodiment of FIG. 2 and the embodiment of FIG. 3, reference is hereby made to the description above accompanying the embodiment of FIG. 2 for a more complete description of the features and elements (and the alternatives to the features and elements) of the embodiment of FIG. 3. Features and elements in the embodiments of FIG. 3 corresponding to features and elements in the embodiment of FIG. 2 are numbered in the 200 series.

The reservoir 212 includes a reservoir body 240 having an inner wall 244. The inner wall 244 partitions the interior of the reservoir body 240 into a first or pressurized chamber 248 and a second or vented chamber 252.

The reservoir 212 includes a primary pump loop inlet 272 at the pressurized chamber 248, a primary pump loop outlet 270 at the pressurized chamber 248, a secondary pump loop outlet 274 at the vented chamber 252 and a secondary pump loop inlet 276 at the pressurized chamber 248. In some embodiments, the primary pump loop inlet 272 and the secondary pump loop inlet 276 are connected.

A piston assembly 280 cooperates with the reservoir 212 to regulate the pressure within the pressurized chamber 248. The piston assembly 280 includes a cylinder 282 forming a cylinder chamber 284 and defining a longitudinal cylinder axis 286. A piston 288 is movable along the axis 286 within the cylinder chamber 284. A seal 290 is positioned between the piston 288 and the inner surface of the cylinder 282. One side of the piston 288 and the cylinder chamber 284 define a first cylinder portion 284a and an opposite side of the piston 288 and the cylinder chamber 284 define a second cylinder portion 284b. The first and second cylinder portions 284a, 284b are sealed from one another so that fluid cannot flow from one to the other.

The piston assembly 280 includes a biasing member 292 that biases the piston 288 towards the first cylinder portion 284a. Thus, the piston 288 is movable axially between a first position in which the biasing member 292 is more relaxed (shown in dashed lines) and a second position in which the biasing member 292 is more compressed or tensioned (shown in solid lines). The axial position of the piston 288 determines the relative axial length of the first and second cylinder portions 284a, b and thus the relative volume of the first and second cylinder portions 284a, b.

The piston assembly 280 can include a stop 294 in the cylinder 282 for limiting the movement of the piston 288 axially towards the first cylinder portion 284a. The stop 294 thus limits the minimum volume (i.e., axial length) of the first cylinder portion 284a. Movement of the piston 288 is away from the first cylinder portion 284a is limited by full compression of the biasing member 292.

The cylinder 282 extends through the inner wall 244 of the reservoir body 240 so that the first cylinder portion 284a is in fluid communication with the pressurized chamber 248. The second cylinder chamber 284b is in fluid communication with the vented chamber 252. The piston 188 therefore exerts a pressurizing force on the fluid within the pressurized chamber 248 that is a function of the strength or biasing force of the biasing member 292.

The overall volume of the pressurized chamber 248 includes the volume of the pressurized chamber 248 that is exterior to the cylinder 282 plus the volume of the first cylinder portion 284a. When the piston 288 is in the first position, the overall volume of the pressurized chamber 248 is reduced. Conversely, when the piston 288 is in the second position, the overall volume of the pressurized chamber 248 is increased.

A valve 256 is positioned to seal a passageway 298 extending through the piston 288 from the first cylinder portion 284a to the second cylinder portion 284b. In the illustrated embodiment, the passageway 298 is coaxial with the cylinder chamber axis 286. The valve 256 includes a check ball 268 biased to the closed position by a biasing member 264. The valve 256 has a closing force that is a function of the biasing force of the valve biasing member 264. The valve closing force sets a maximum pressure within the pressurized chamber 248. Excess fluid is released through the valve 256 to the vented chamber 252. In some embodiments, a mechanism is provided in the passageway 298 to prevent check ball 268 from inadvertantly falling out of the piston 288.

Thus, the invention provides, among other things, a variable volume reservoir for a hydraulic pump system. Various features and advantages of the invention are set forth in the following claims.

What is claimed is:

1. A reservoir for a hydraulic pump system, the reservoir comprising:
a reservoir body;
an inner wall dividing an interior of the reservoir body into a first pressure chamber and a second pressure chamber;
a one-way valve connecting the first pressure chamber and the second pressure chamber for selectively permitting fluid flow from the first pressure chamber into the second pressure chamber; and
a piston assembly including a cylinder and a piston, the piston being movable within the cylinder, wherein a first side of the piston and the cylinder form a first cylinder portion and a second side of the piston and the cylinder form a second cylinder portion, and a biasing member biasing the piston towards the first cylinder chamber, wherein the first pressure chamber is in fluid communication with the first cylinder portion.

2. The reservoir of claim 1, wherein the cylinder is exterior to the reservoir.

3. The reservoir of claim 1, wherein the cylinder extends through the inner wall.

4. The reservoir of claim 1, wherein the one-way valve selectively seals a first passageway through the piston from the first cylinder portion to the second cylinder portion.

5. The reservoir of claim 1, wherein a passageway from the first cylinder portion to the second cylinder portion is provided between the piston and an inner surface of the cylinder.

6. The reservoir of claim 1, wherein the piston is movable between a first position and a second position, wherein in the first position the first pressure chamber has a first volume and in the second position the first pressure chamber has a second volume.

7. The reservoir of claim 1, wherein the biasing member has a biasing force and the one-way valve has a valve closing force, wherein the biasing force is less than the valve closing force.

8. A hydraulic pump system for a construction vehicle, the hydraulic pump system comprising:
a reservoir including:
a first pressure chamber and a second pressure chamber,
a one-way valve connecting the first pressure chamber and the second pressure chamber, the one-way valve selectively permitting fluid flow from the first pressure chamber into the second pressure chamber, and
a piston assembly including a cylinder and a piston in sealing engagement with an inner wall of the cylinder, the piston being movable within the cylinder, wherein a first side of the piston and the cylinder form a first cylinder portion and a second side of the piston and the cylinder form a second cylinder portion, and a biasing member biasing the piston towards the first cylinder portion, wherein the first cylinder portion is in fluid communication with the first pressure chamber,
a primary pump loop connecting to the reservoir, wherein fluid flows from the first pressure chamber, through the primary pump loop and into the first pressure chamber; and
a secondary pump loop connecting to the reservoir, wherein fluid in the secondary pump loop flows from the second pressure chamber, through the secondary pump loop and into the first pressure chamber.

9. The hydraulic pump system of claim 8, wherein the cylinder is outside of the reservoir.

10. The hydraulic pump system of claim 8, wherein the cylinder is inside of the reservoir.

11. The hydraulic pump system of claim 8, wherein the one-way valve selectively seals a passageway through the piston.

12. The hydraulic pump system of claim 8, wherein a passageway from the first cylinder portion to the second cylinder portion is provided between the piston and an inner surface of the cylinder.

13. The hydraulic pump system of claim 8, wherein the piston is movable between a first position and a second position, wherein in the first position the first pressure chamber has a first volume and in the second position the first pressure chamber has a second volume.

14. The hydraulic pump system of claim 8, wherein the biasing member has a biasing force and the one-way valve has a valve closing force, wherein the biasing force is less than the valve closing force.

15. The hydraulic pump system of claim 8, wherein the primary pump loop includes a piston pump.

16. A reservoir for a hydraulic pump system, the reservoir comprising:
a first pressure chamber;
a second pressure chamber;
a passageway connecting the second pressure chamber to the first pressure chamber;
a movable body positioned in the passageway, the body movable between a first position in which the first pressure chamber has a first volume and a second position in which the first pressure chamber has a second volume; and
a one-way valve between the first pressure chamber and the second pressure chamber.

17. The reservoir of claim 16, further comprising a biasing member biasing the movable body towards the first position.

18. The reservoir of claim 17, wherein the biasing member has a biasing force and the one-way valve has a valve closing force, wherein the biasing force is less than the valve closing force.

19. The reservoir of claim 16, further comprising a primary pump inlet at the first pressure chamber, a primary pump outlet at the first pressure chamber, a secondary pump inlet at the second pressure chamber, and a secondary pump outlet at the first pressure chamber.

20. The reservoir of claim 16, wherein the one-way valve selectively seals a passageway in the movable body.
